(19) United States
(12) Patent Application Publication
(10) Pub. No.: US 2003/0177467 A1
(43) Pub. Date: Sep. 18, 2003

(54) Opc mask manufacturing method, opc mask, and chip

(76) Inventors: Hidetoshi Ohnuma, Kanagawa (JP); Chie Niikura, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/311,157

(22) PCT Filed: Apr. 5, 2002
(86) PCT No.: PCT/JP02/03449

(30) Foreign Application Priority Data
Apr. 13, 2001 (JP) P2001-115632

(51) Int. Cl. G06F 17/50

(52) U.S. Cl. 716/19; 716/21

(57) ABSTRACT

A method of producing an OPC mask capable of suppressing the dispersion of the line width of a pattern actually formed on a wafer by performing a simulation with the influences of space dependency faithfully reflected thereon, the OPC mask, and a chip are provided. Measured data on a novel test pattern for a test mask is measured for the line width of each gate pattern. Simulation computation is conducted based on the measured data and design data of the novel test pattern, and simulation data of the novel test pattern deformed in shape by the optical proximity effect is outputted. When simulation accuracy is acceptable, a kernel is generated. Simulation is conducted by use of the kernel.

### TECHNICAL FIELD

The present invention relates to a method of producing an OPC mask which preliminarily corrects the shape of a mask pattern by allowing for a deformation of a pattern based on an optical proximity effect, the OPC mask, and a chip.

### BACKGROUND ART

In recent years, enhancement of integration of semiconductors has progressed, and miniaturization of gate length has proceeded more and more. Therefore, at the time of transferring a mask pattern from a mask to a wafer, it is required to resolve a pattern having a size smaller than the wavelength of the light used in an exposure apparatus.

In order to faithfully resolve a pattern with a line width shorter than the wavelength of the light, an OPC (Optical Proximity Correction) technology for preliminarily correcting the shape of a mask pattern in consideration of the deformation of the pattern on the wafer due to the optical proximity effect is used.

As one of such OPC technology, there is the rule base OPC.

The rule base OPC is performed as follows. Namely, a test mask pattern is produced by use of test patterns representing all the patterns allowed on a design basis, this mask pattern is transferred onto a wafer, and etching is conducted, to produce a test wafer.

Based on measurement data on the shape of the pattern on the test wafer and design data on the test mask pattern, a design rule for determining bias data to be added to the design data of the mask pattern is formed. Then, the mask pattern is corrected based on the design rule. The correction is conducted in the step of layout CAD for the mask pattern. A mask produced through such an optical proximity correction is called “OPC mask”.

In the above-mentioned rule base OPC, enormous labor is required for performing measurement of the test patterns representing all the patterns allowed on the design basis. In addition, such operations must be repeated each time the process (production process) is changed, leading to that much time and cost are required.

In order to solve the problems involved in the rule base OPC mentioned above, a technology called simulation base OPC has been developed.

In the simulation base OPC, a kernel (process model) expressing a process of transfer taking the optical proximity effect into account is formed based on measurement results of a small number of test patterns prepared preliminarily, differences between the shape of the mask pattern and the shape of pattern transferred onto the wafer by use of the mask pattern are determined by simulation computation using the kernel, and the mask pattern is corrected based on the results of the simulation.

In the simulation base OPC, it is unnecessary to measure a large amount of test patterns, as contrasted to the rule base OPC. Therefore, the simulation base OPC is advantageous for saving time and cost.

However, in the above-mentioned simulation base OPC, it is difficult to faithfully reflect the space dependency on the simulation results. Here, the space dependency is the phenomenon in which, at the time of forming a pattern having a predetermined line width on a wafer, the line width of the pattern is affected according to the variation in the size of the space between a pattern and the adjacent pattern, namely, the denseness of the spaces between the patterns. Therefore, there is the problem that the line width of the pattern actually formed on the wafer is dispersed largely.

It is an object of the present invention to provide a method of producing an OPC mask which can restrain the dispersion of the line width of a pattern actually formed on a wafer by performing a simulation with the influences of the space dependency faithfully reflected thereon, the OPC mask, and a chip.

### DISCLOSURE OF INVENTION

In order to attain the above object, the present invention provides a method of producing an OPC mask, including: a simulation step for determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; and a correction step for correcting design data of the shape of the mask pattern so that the shape of the pattern transferred onto the wafer will coincide with the desired shape based on the design data, based on the results of the simulation step; the simulation step being performed by use of a simulation model expressing the process of transfer of the mask pattern, namely, a kernel; wherein the kernel is generated based on design data of the shape of a test mask pattern and measured data of the shape of a test wafer pattern actually formed by transfer and etching conducted by use of the test mask pattern, the test pattern contains a plurality of first pattern groups each constituted by arranging a plurality of belt form gate patterns in parallel to each other and at the same interval in the line width direction, each of the gate patterns having a line width substantially equal to the predetermined minimum size and extending in a linear form, and the plurality of first pattern groups differ from each other in the size of the interval of the gate patterns.

Therefore, the kernel for performing the simulation is generated based on the test pattern containing the first pattern groups.

In addition, the present invention provides a method of producing an OPC mask, including: a simulation step for determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; and a correction step for correcting design data of the shape of the mask pattern so that the shape of the pattern transferred onto the wafer will coincide with the desired shape based on the design data, based on the results of the simulation step; the simulation step being performed by use of a simulation model expressing the process of transfer of the mask pattern, namely, a kernel; wherein the kernel is generated based on design data of the shape of a test mask pattern and measured data of the shape of a test wafer pattern actually formed by transfer and etching conducted by use of the test mask pattern, the test pattern contains a plurality of second pattern groups each constituted by arranging a plurality of belt form gate patterns in parallel to each other and at the same interval in the line width direction, each of the gate patterns having a line width smaller than the predetermined minimum size and extending in a linear form, and the plurality of second pattern groups differ from each other in the size of the interval of the gate patterns.

Therefore, the kernel for performing the simulation is generated based on the test pattern containing the second pattern groups.

In addition, the present invention provides a method of producing an OPC mask, including: a simulation step for determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; and a correction step for correcting design data of the shape of the mask pattern so that the shape of the pattern transferred onto the wafer will coincide with the desired shape based on the design data, based on the results of the simulation step; the simulation step being performed by use of a simulation model expressing the process of transfer of the mask pattern, namely, a kernel; wherein the kernel is generated based on design data of the shape of a test mask pattern and measured data of the shape of a test wafer pattern actually formed by transfer and etching conducted by use of the test mask pattern, the test pattern contains a plurality of third pattern groups each constituted by arranging a plurality of belt form gate patterns in parallel to each other and at the same interval in the line width direction, each of the gate patterns having a line width greater than the predetermined minimum size and extending in a linear form, and the plurality of third pattern groups differ from each other in the size of the interval of the gate patterns.

Therefore, the kernel for performing the simulation is generated based on the test pattern containing the third pattern groups.

In addition, the present invention provides an OPC mask produced by the steps of: determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; correcting design data of the shape of the mask pattern so that the shape of the pattern transferred onto the wafer will coincide with the desired shape based on the design data, based on the results of the simulation computation; the simulation computation being performed by use of a simulation model expressing the process of transfer of the mask pattern, namely, a kernel; and producing the OPC mask based on the corrected design data; wherein the kernel is generated based on design data of the shape of a test mask pattern and measured data of the shape of a test wafer pattern actually formed by transfer and etching conducted by use of the test mask pattern, the test pattern contains a plurality of first pattern groups each constituted by arranging a plurality of belt form gate patterns in parallel to each other and at the same interval in the line width direction, each of the gate patterns having a line width substantially equal to the predetermined minimum size and extending in a linear form, and the plurality of first pattern groups differ from each other in the size of the interval of the gate patterns.

Therefore, the kernel for performing the simulation is generated based on the test pattern containing the first pattern groups.

In addition, the present invention provides an OPC mask produced by the steps of: determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; correcting design data of the shape of the mask pattern so that the shape of the pattern transferred onto the wafer will coincide with the desired shape based on the design data, based on the results of the simulation computation; the simulation computation being performed by use of a simulation model expressing the process of transfer of the mask pattern, namely, a kernel; and producing the OPC mask based on the corrected design data; wherein the kernel is generated based on design data of the shape of a test mask pattern and measured data of the shape of a test wafer pattern actually formed by transfer and etching conducted by use of the test mask pattern, the test pattern contains a plurality of second pattern groups each constituted by arranging a plurality of belt form gate patterns in parallel to each other and at the same interval in the line width direction, each of the gate patterns having a line width smaller than the predetermined minimum size and extending in a linear form, and the plurality of second pattern groups differ from each other in the size of the interval of the gate patterns.

Therefore, the kernel for performing the simulation is generated based on the test pattern containing the second pattern groups.

In addition, the present invention provides an OPC mask produced by the steps of: determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; correcting design data of the shape of the mask pattern so that the shape of the pattern transferred onto the wafer will coincide with the desired shape based on the design data, based on the results of the simulation computation; the simulation computation being performed by use of a simulation model expressing the process of transfer of the mask pattern, namely, a kernel; and producing the OPC mask based on the corrected design data; wherein the kernel is generated based on design data of the shape of a test mask pattern and measured data of the shape of a test wafer pattern actually formed by transfer and etching conducted by use of the test mask pattern, the test pattern contains a plurality of third pattern groups each constituted by arranging a plurality of belt form gate patterns in parallel to each other and at the same interval in the line width direction, each of the gate patterns having a line width greater than the predetermined minimum size and extending in a linear form, and the plurality of third pattern groups differ from each other in the size of the interval of the gate patterns.

Therefore, the kernel for performing the simulation is generated based on the test pattern containing the third pattern groups.

In addition, the present invention provides a chip diced from a wafer produced based on an OPC mask, the OPC mask being produced by the steps of: determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; correcting design data of the shape of the mask pattern so that the shape of the pattern transferred onto the wafer will coincide with the desired shape based on the design data, based on the results of the simulation computation; the simulation computation being performed by use of a simulation model expressing the process of transfer of the mask pattern, namely, a kernel; and producing the OPC mask based on the corrected design data; wherein the kernel is generated based on design data of the shape of a test mask pattern and measured data of the shape of a test wafer pattern actually formed by transfer and etching conducted by use of the test mask pattern, the test pattern contains a plurality of first pattern groups each constituted by arranging a plurality of belt form gate patterns in parallel to each other and at the same interval in the line width direction, each of the gate patterns having a line width substantially equal to the predetermined minimum size and extending in a linear form, and the plurality of first pattern groups differ from each other in the size of the interval of the gate patterns.

Therefore, the kernel for performing the simulation is generated based on the test pattern containing the first group patterns.

In addition, the present invention provides a chip diced from a wafer produced based on an OPC mask, the OPC mask being produced by the steps of: determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; correcting design data of the shape of the mask pattern so that the shape of the pattern transferred onto the wafer will coincide with the desired shape based on the design data, based on the results of the simulation computation; the simulation computation being performed by use of a simulation model expressing the process of transfer of the mask pattern, namely, a kernel; and producing the OPC mask based on the corrected design data; wherein the kernel is generated based on design data of the shape of a test mask pattern and measured data of the shape of a test wafer pattern actually formed by transfer and etching conducted by use of the test mask pattern, the test pattern contains a plurality of second pattern groups each constituted by arranging a plurality of belt form gate patterns in parallel to each other and at the same interval in the line width direction, each of the gate patterns having a line width smaller than the predetermined minimum size and extending in a linear form, and the plurality of second pattern groups differ from each other in the size of the interval of the gate patterns.

Therefore, the kernel for performing the simulation is generated based on the test pattern containing the second pattern groups.

In addition, the present invention provides a chip diced from a wafer produced based on an OPC mask, the OPC mask being produced by the steps of: determining the difference between the shape of a mask pattern designed according to a design rule defined by a predetermined minimum size value and formed on a mask and the shape of a pattern transferred onto a wafer by use of the mask pattern, by simulation computation taking the optical proximity effect into account; correcting design data of the shape of the mask pattern so that the shape of the pattern transferred onto the wafer will coincide with the desired shape based on the design data, based on the results of the simulation computation; the simulation computation being performed by use of a simulation model expressing the process of transfer of the mask pattern, namely, a kernel; and producing the OPC mask based on the corrected design data; wherein the kernel is generated based on design data of the shape of a test mask pattern and measured data of the shape of a test wafer pattern actually formed by transfer and etching conducted by use of the test mask pattern, the test pattern contains a plurality of third pattern groups each constituted by arranging a plurality of belt form gate patterns in parallel to each other and at the same interval in the line width direction, each of the gate patterns having a line width greater than the predetermined minimum size and extending in a linear form, and the plurality of third pattern groups differ from each other in the size of the interval of the gate patterns.

Therefore, the kernel for performing the simulation is generated based on the test pattern containing the third pattern groups.

### BRIEF DESCRIPTION OF DRAWINGS

FIG. 1 is a flow chart showing the procedures of a process for generating a kernel in a method of producing an OPC mask according to the present embodiment;

FIG. 2 is a block diagram illustrating input/output of data in a simulation tool;

FIG. 3 is a block diagram illustrating input/output of design data in a simulation tool;

FIG. 4 is a flow chart showing the procedures of production of an OPC mask;

FIG. 5A is an illustration of the constitution of second pattern groups,

FIG. 5B is an illustration of the constitution of first pattern groups, and

FIG. 5C is an illustration of the constitution of third pattern groups;

FIG. 6A is a diagram showing the results of simulation based on only an existing test pattern with design data (target value) of line width of a gate pattern of 150 nm,

FIG. 6B is a diagram showing the results of simulation based on only an existing test pattern with design data (target value) of line width of a gate pattern of 190 nm,

FIG. 6C is a diagram showing the results of simulation based on the first pattern groups with design data (target value) of line width of a gate pattern of 150 nm, and

FIG. 6D is a diagram showing the results of simulation based on the first pattern groups with design data (target value) of line width of a gate pattern of 190 nm;

FIG. 7A is a diagram showing the results of simulation based on the second pattern groups with design data (target value) of line width of a gate pattern of 150 nm,

FIG. 7B is a diagram showing the results of simulation based on the second pattern group with design data (target value) of line width of a gate pattern of 190 nm,

FIG. 7C is a diagram showing the results of simulation based on the third pattern groups with design data (target value) of line width of a gate pattern of 150 nm, and

FIG. 7D is a diagram showing the results of simulation based on the second pattern groups with design data (target value) of line width of a gate pattern of 190 nm;

FIG. 8 is a diagram illustrating the comparison between the measured data of line width of a gate pattern on an actual product and each kind of simulation data; and

FIGS. 9A to 9D are diagrams illustrating the comparison between dispersions of simulation data on a gate pattern in an actually produced mask, in which FIG. 9A is a diagram showing simulation data when simulation is conducted based on only an existing test pattern, FIG. 9B is a diagram showing simulation data when simulation based on the first pattern groups is conducted in addition to simulation based on the existing test pattern, FIG. 9C is a diagram showing simulation data when simulation based on the second pattern groups is conducted in addition to simulations based on the existing test pattern and on the first pattern groups, FIG. 9D is a diagram showing simulation data when simulation based on the third pattern groups is conducted in addition to simulations based on the existing test pattern, on the first pattern groups and on the second pattern groups.

### BEST MODE FOR CARRYING OUT THE INVENTION

Now, embodiments of a method of producing an OPC mask, the OPC mask and a chip according to the present invention will be described below.

As shown in FIG. 3, in the present embodiment, a simulation tool 10 is used for obtaining a mask pattern for the OPC mask.

The simulation tool 10 is realized by use of a software operating on a computer, and includes a simulation model which represents the process of transfer of the mask pattern, namely, a kernel 12. The kernel 12 is generated according to the procedures described later.

As shown in FIG. 3, when design data of a desired pattern to be formed on a wafer (design data before correction of a mask pattern) is inputted to the simulation tool 10, the simulation tool 10 determines the differences between the shape of the mask pattern and the shape of the pattern transferred onto the wafer by use of the mask pattern, by simulation computation taking the optical proximity effect into account. Then, the simulation tool 10 corrects the design data of the shape of the mask pattern so that the shape of the pattern transferred onto the wafer will coincide with the desired shape based on the design data, based on the results of the simulation computation, and outputs the corrected design data.

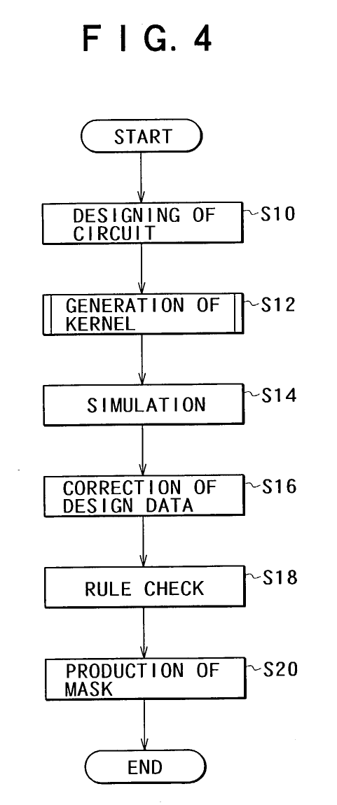

Next, the procedures of production of the OPC mask will be detailed below referring to FIG. 4.

First, designing of a circuit to be a mask pattern on a mask is conducted (S10). The circuit designing is conducted after a design rule defined by the minimum size value of line width of the pattern is set. In this embodiment, the minimum size value is 150 nm.

The minimum size value corresponds to a production assured limit value of the wafer to be produced according to the design rule defined by the minimum size value.

Next, generation of the kernel 12 described later is conducted (S12).

When the kernel 12 is generated, the design data before correction is inputted into the kernel 12, whereby the differences between the shape of the mask pattern designed according to the design rule defined by the predetermined minimum size value and formed on the mask and the shape of the pattern transferred onto the wafer by use of the mask pattern are computed by simulation computation taking the optical proximity effect into account (S14).

Subsequently, based on the results of the simulation step, the design data of the shape of the mask pattern is corrected so that the shape of the pattern transferred onto the wafer will coincide with the desired shape based on the design data (S16).

Next, rule check about the corrected design data is conducted, to complete the design data (S18). If it is found as a result of the rule check that the kernel needs correction, the kernel is corrected, and then step S14 is reentered to repeat the same process.

Subsequently, the design data thus corrected is supplied to a mask layout CAD, and a corrected mask, namely, an OPC mask is produced (S20).

Then, a wafer is produced by use of the OPC mask in a lithographic step, and the wafer is diced to produce chips.

In the present embodiment, step S14 corresponds to the simulation step in the present invention, and step S16 corresponds to the correction step in the present invention.

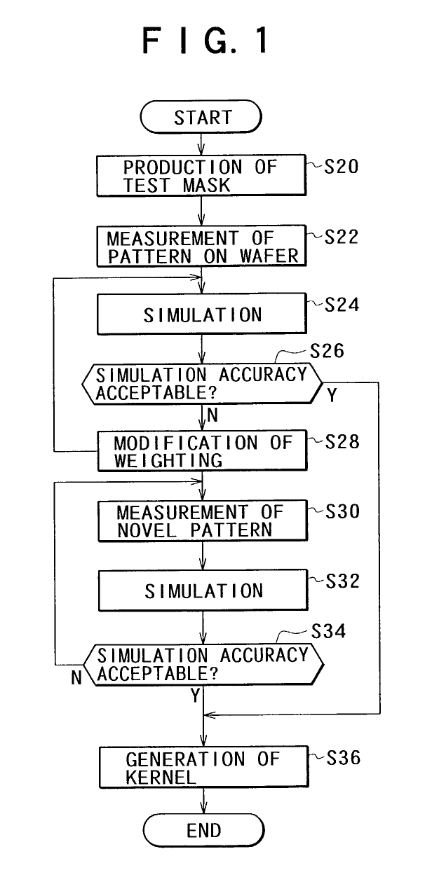

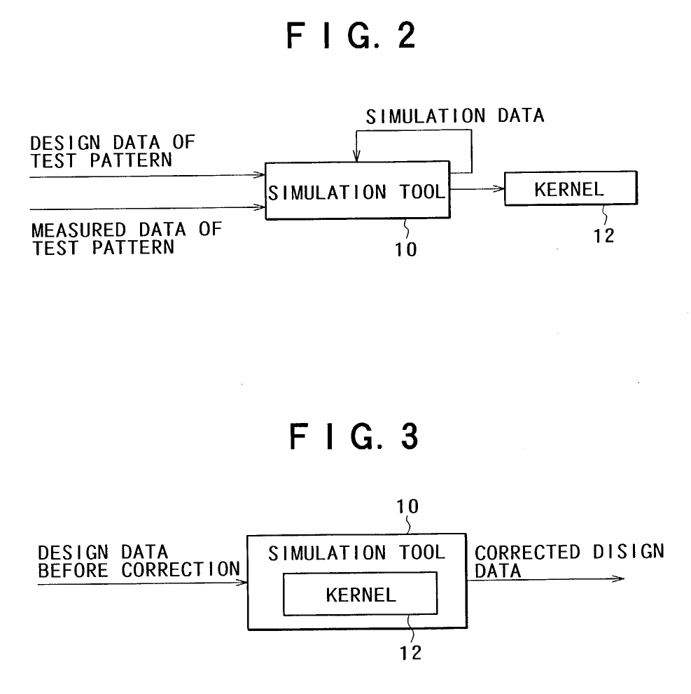

FIG. 1 is a flow chart showing the procedures of a process for generating a kernel in the method of producing an OPC mask according to the present embodiment, and FIG. 2 is a block diagram illustrating input/output of data in the simulation tool.

In FIG. 1, steps S20, S22, S24, S26, S28 and S36 are processes corresponding to the prior art, and steps S30, S32, S34 and S36 are the processes corresponding to the present invention.

Generation of the kernel 12 is conducted as follows.

First, a test mask is produced (S20). The test mask includes an existing test pattern attached to the simulation tool 10, and a novel test pattern which will be described later.

The existing test pattern is comprised of a plurality of gate patterns extending in a linear form and a combination of two gate patterns crossing in the form of a cross, with the line width of each gate pattern varied by a predetermined value at a time.

The existing test pattern does not contain belt form gate patterns extending in a linear form and spaced from and in parallel to each other.

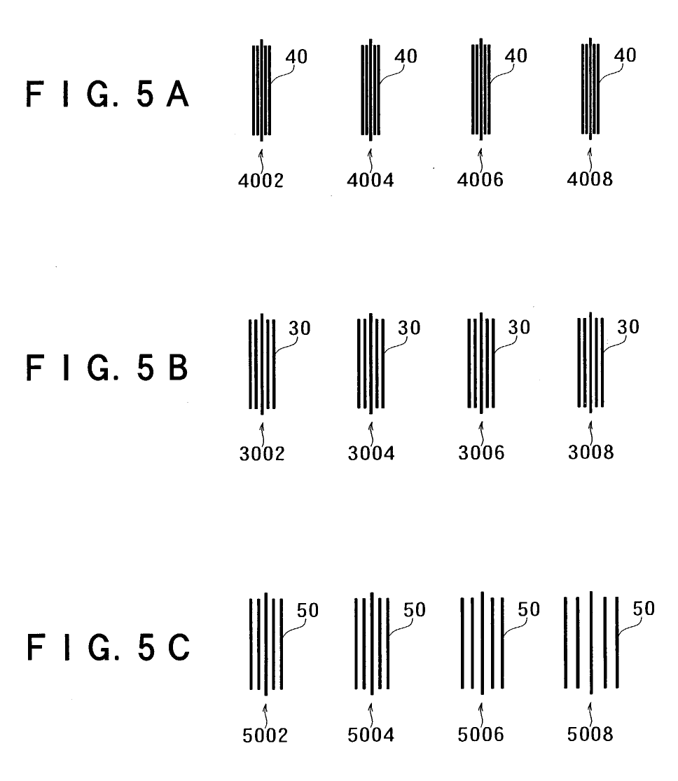

As shown in FIG. 5B, the novel test pattern contains a plurality of first pattern groups 3002, 3004, 3006, 3008 each constituted by arranging a plurality of belt form gate patterns 30 arranged in parallel to each other and spaced from each other in the line width direction, each of the gate patterns 30 having a line width L1 (150 nm) of the predetermined minimum size and extending in a linear form.

Where the spaces (intervals) between the gate patterns 30 in each of the first pattern groups 3002, 3004, 3006 and 3008 are SP10, SP11, SP12 and SP13, the spaces (intervals) are different from each other and are in the relationship of SP10<SP11<SP12<SP 13.

In addition, as shown in FIG. 5A, the novel test pattern contains a plurality of second pattern groups 4002, 4004, 4006, 4008 each constituted by arranging a plurality of belt form gate patterns 40 in parallel to each other and spaced from each other in the line width direction, each of the gate patterns 40 having a line width L2 (140 nm) smaller than the line width L1 (150 nm) of the predetermined minimum size and extending in a linear form.

Where the spaces (intervals) between the gate patterns 30 in each of the second pattern groups 4002, 4004, 4006 and 4008 are SP20, SP21, SP22 and SP23, the spaces (intervals) are different from each other and are in the relationship of SP20<SP21<SP22<SP23.

Besides, as shown in FIG. 5C, the novel test pattern contains a plurality of third pattern groups 5002, 5004, 5006, 5008 each constituted by arranging a plurality of belt form gate patterns 50 in parallel to each other and spaced from each other in the line width direction, each of the gate patterns 50 having a line width L3 (for example, 150 nm) greater than the line width L1 (150 nm) of the predetermined minimum size and extending in a linear form.

Where the spaces (intervals) between the gate patterns 30 in each of the third pattern groups 5002, 5004, 5006 and 5008 are SP30, SP31, SP32 and SP 33, the spaces (intervals) are different from each other and are in the relationship of SP30<SP31<SP32<SP33.

Next, measurement of the pattern etched on the wafer through transfer of the existing test pattern and the novel test pattern by use of the test mask is conducted to obtain measured data of the test pattern (S22).

The measurement is conducted only for the measured data corresponding to the design data of the existing test pattern previously selected. The measurement for the existing test pattern is conducted only at preset portions.

Subsequently, as shown in FIG. 2, the design data of the existing test pattern formed on the test mask is inputted to the simulation tool 10, simulation computation is conducted based on the design data, and data of the existing test pattern deformed in shape by the optical proximity effect (hereinafter referred to as simulation data) is outputted (S24).

The simulation computation is conducted under the condition where the design data portion desired to be particularly enhanced in simulation accuracy, among the design data of the existing test pattern, is heavily weighted and the other design data portions are lightly weighted.

Next, as shown in FIG. 2, the simulation data and the measured data are compared with each other in the simulation tool 10, and it is decided whether the simulation accuracy is acceptable (S26).

In concrete, the simulation accuracy is decided to be acceptable if there is no portion where the difference between the line width in the simulation data and the line width in the measured data exceeds a predetermined reference value, and the simulation accuracy is decided to be unacceptable if there is one or more such portions.

Here, the difference between the line width in the simulation data and the line width in the measured data corresponds to the difference between “the deviation amount EPE (Edge Placement Error) between the line width in the simulation data and the line width (target value) in the design data of the gate pattern to be formed on the wafer” and “the deviation amount EPE between the line width in the measured data and the line width (target value) in the design data of the gate pattern to be formed on the wafer”.

If the result of step S26 is acceptable (“Y”), the accuracy of simulation by the kernel 12 is satisfactory, so that the simulation tool 10 generates the kernel 12 (S36), and finishes the process.

On the other hand, if the result of step 26 is unacceptable (“N”), modification of the weighting for the design data of the existing test pattern and addition and deletion of the existing test patterns are conducted (S28), and a series of process consisting of steps S24, S26 and S28 is conducted. If the simulation accuracy is unacceptable even after the series of process is repeated a predetermined number of times, for example, six times, the next step is entered.

The process of modification of the weighting and addition and deletion of the existing test patterns is a function already incorporated in the simulation tool 10, and is not directly related to the present invention; therefore, detailed description of this process is omitted.

Next, measurement of the first pattern groups 3002, 3004, 3006, 3008 of the novel test pattern is newly conducted to obtain measured data (S30). The measured data is data obtained by measurement of the line width of each gate pattern 30.

Then, simulation computation is conducted based on the design data of the first pattern groups 3002, 3004, 3006, 3008, and simulation data of the novel test pattern deformed in shape by the optical proximity effect is outputted (S32).

Subsequently, as shown in FIG. 2, the simulation data of the first pattern groups and the measured data of the first pattern groups are compared with each other in the simulation tool 10, and it is decided whether the simulation accuracy is acceptable (S34).

In concrete, the simulation accuracy is decided to be acceptable if there is no portion where the difference between the line width in the simulation data and the line width in the measured data exceeds a predetermined reference value, and the simulation accuracy is decided to be unacceptable if there is one or more such portions. The predetermined reference value may be arbitrarily set; in this example, it is set at 5 nm.

If the result of step S34 is acceptable (“Y”), the accuracy of simulation by the kernel 12 is satisfactory, so that the simulation tool 10 generates the kernel 12 (S36), and finishes the process.

On the other hand, if the result of step S34 is unacceptable (“N”), step S30 is reentered.

Next, measurement of the second pattern groups 4002, 4004, 4006, 4008 of the novel test pattern is newly conducted to obtain measured data (S30). The measured data is data obtained by measurement of the line width of each gate pattern 40.

Subsequently, the process of steps S32 and S34 is repeated in the same manner as in the case of the first pattern groups.

If the result of step S34 is acceptable (“Y”), the accuracy of simulation by the kernel 12 is satisfactory, so that the simulation tool 10 generates the kernel 12 (S36), and finishes the process.

On the other hand, if the result of step S34 is unacceptable (“N”), the next step is entered.

Next, measurement of the third pattern groups 5002, 5004, 5006, 5008 of the novel test pattern is newly conducted to obtain measured data (S30). The measured data is data obtained by measurement of the line width of each gate pattern 50.

Subsequently, the process of steps S32 and S34 is repeated in the same manner as in the case of the first pattern groups.

If the result of step 34 is acceptable (“Y”), the accuracy of simulation by the kernel 12 is satisfactory, so that the simulation tool 10 generates the kernel 12 (S36), and finishes the process.

If the result of step 34 for the third pattern groups is unacceptable (“N”), the process is stopped.

Next, the results of comparison of the accuracies of simulations conducted according to the process of FIG. 1 will be described in concrete.

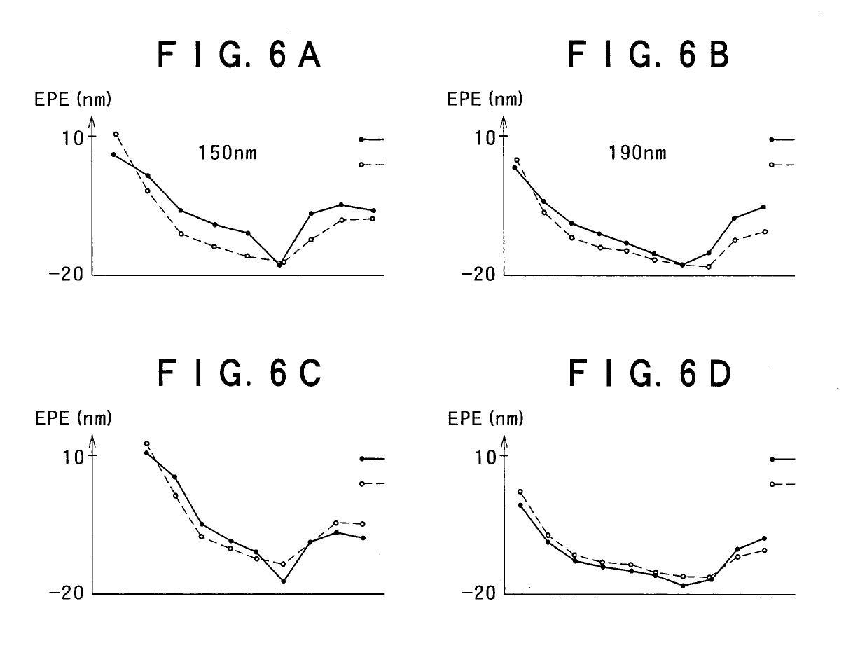

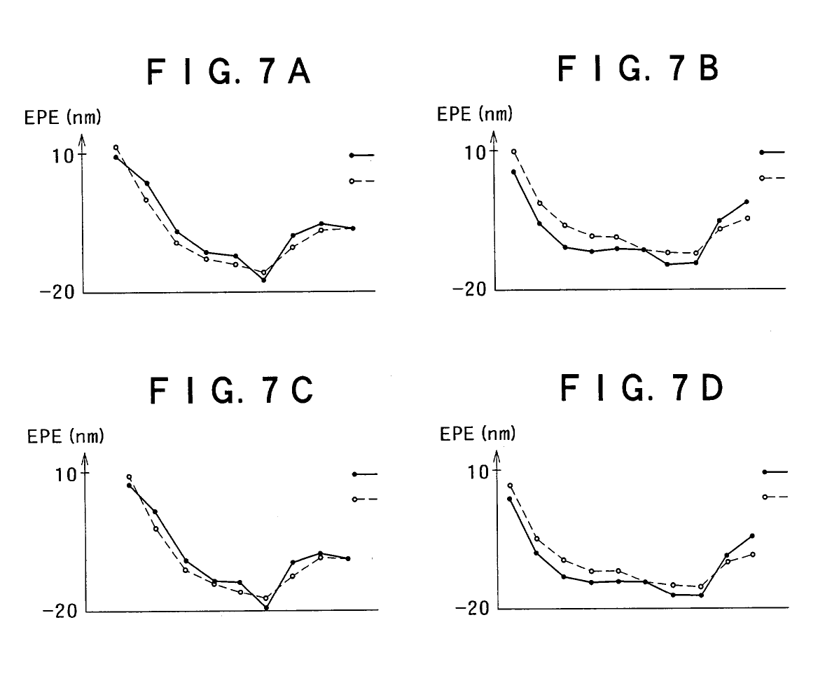

FIGS. 6A to 6D and FIGS. 7A to 7D are diagrams illustrating the comparison between measured data and simulation data, in each of which the axis of abscissas represents the location (portion) of measurement, and the axis of ordinates represents the deviation amount EPE of the line width of gate patterns from the design value. In the figures, the solid lines show simulation data, and the broken lines show measured data.

FIGS. 6A, 6C, 7A and 7C correspond to the cases where the design data (target value) of the line width of gate patterns is 150 nm, and FIGS. 6B, 6D, 7B and 7D correspond to the cases where the design data (target value) of the line width of gate patterns is 190 nm.

FIGS. 6A and 6B correspond to the condition where steps S20 to S26 in the flow chart of FIG. 1 have been conducted, and show the results of simulation based on only the existing test pattern.

FIGS. 6C and 6D show the simulation results in the cases where simulation for the first pattern groups of the novel test pattern is further conducted after simulation based on only the existing test pattern is conducted.

FIGS. 7A and 7B show the simulation results in the cases where simulation for the second pattern groups is further conducted after simulations for the existing test pattern and the first pattern groups are conducted.

FIGS. 7C and 7D show the simulation results in the cases where simulation for the third pattern groups is further conducted after simulations for the existing test pattern, the first pattern groups and the second pattern groups are conducted.

It is seen from these results that in both the cases where the design data of the gate patterns is 150 nm and the cases where the design data of the gate patterns is 190 nm, the differences between the simulation data and the measured data are smaller when the simulation or simulations based on the novel test pattern are conducted.

Namely, it was confirmed that, by use of the kernel 12 generated by performing simulations for the first, second and third pattern groups, it is possible to perform a simulation with the influences of space dependency of gate patterns faithfully reflected thereon, and to enhance simulation accuracy.

Next, comparison between measured data and simulation data was conducted; here, the measured data was obtained by producing a mask of an actual product by use of a kernel 12 generated according to the flow chart of FIG. 1, producing a wafer through transfer and etching by use of the mask, and measuring the line width of gate patterns formed on the wafer.

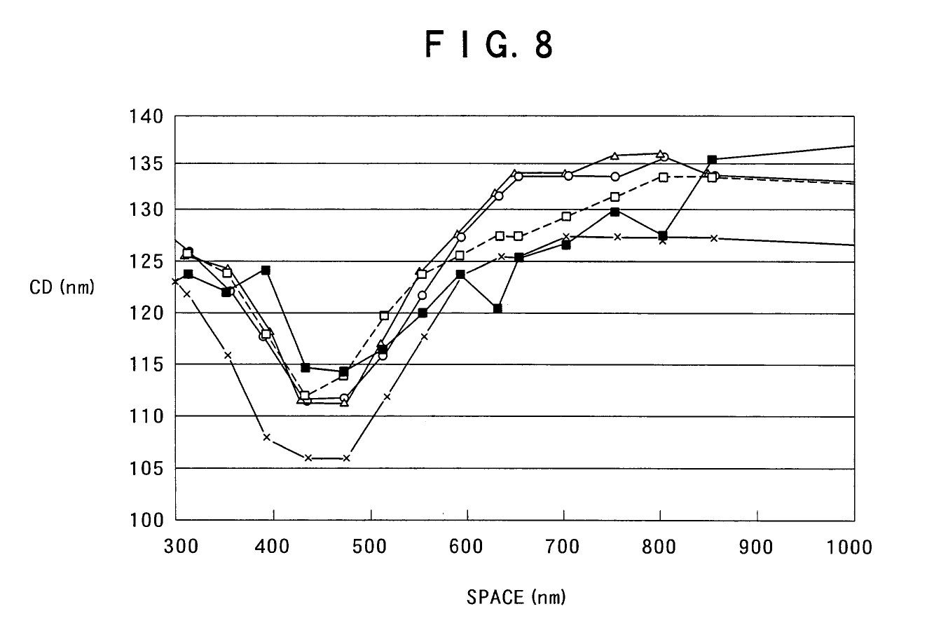

FIG. 8 is a diagram illustrating comparison between the measured data of the line width of gate patterns in the actual product and each kind of simulation data. The design data (target value) of the line width of the gate patterns is 150 nm.

In the figure, the axis of abscissas represents the space (interval) between the gate patterns in the line width direction in terms of nm, and the axis of ordinates represents the line width CD of the gate patterns in terms of nm.

In the figure, ▪ indicates the measured data, □ indicates the simulation data based on only the existing test pattern, × indicates the simulation data in the case where simulation for the first pattern groups is conducted in addition to the simulation based on the existing test pattern, Δ indicates the simulation data in the case where simulation for the second pattern groups is conducted in addition to the simulations for the existing test pattern and the first test pattern, and ◯ indicates the simulation data in the case where simulation for the third pattern groups is conducted in addition to the simulations for the existing test pattern, the first test pattern and the second test pattern.

Also in FIG. 8, it is seen that the differences between the simulation data and the measured data are smaller when the simulation or simulations based on the novel test pattern have been conducted.

Namely, it was confirmed that, by use of the kernel 12 generated by performing simulations for the first, second and third pattern groups, it is possible to perform a simulation with the influences of space dependency of gate patterns faithfully reflected thereon, and to enhance simulation accuracy, in the same manner as in the cases of FIGS. 6A to 6D and FIGS. 7A to 7D.

Next, comparison was conducted of dispersions of the line width in simulation data in the cases where simulations were conducted in the same manner as in the case of FIG. 8, for masks of actual products formed by use of the kernels 12 generated according to the flow chart of FIG. 1.

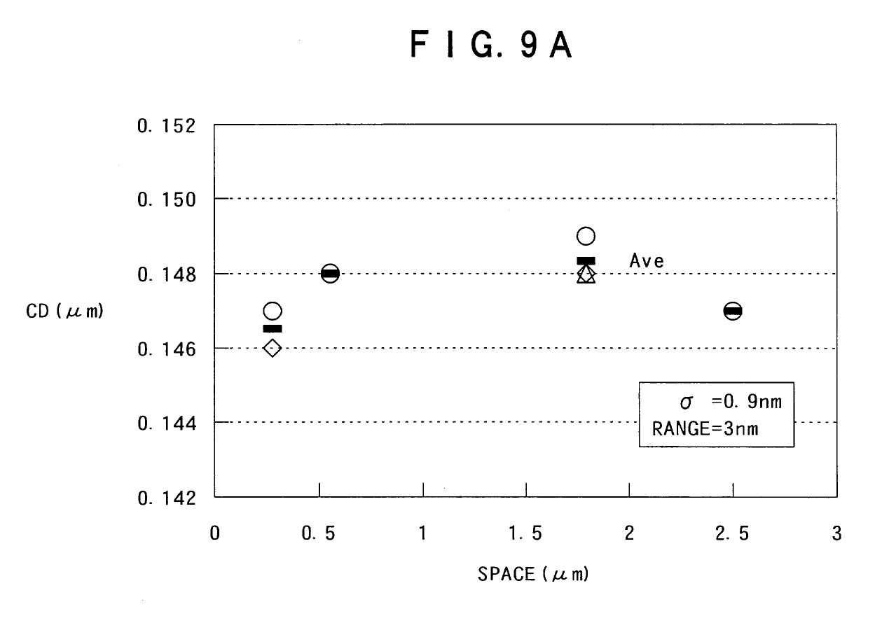

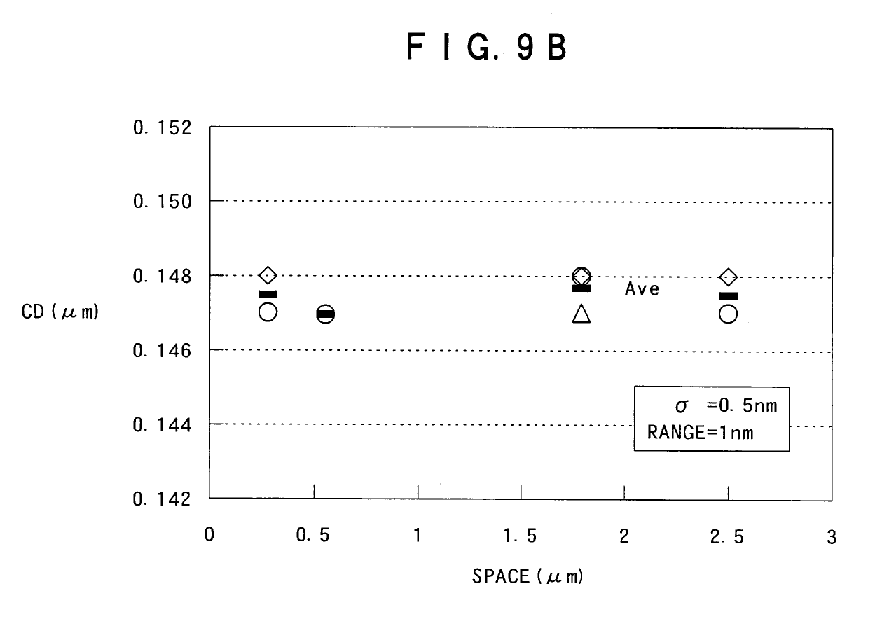

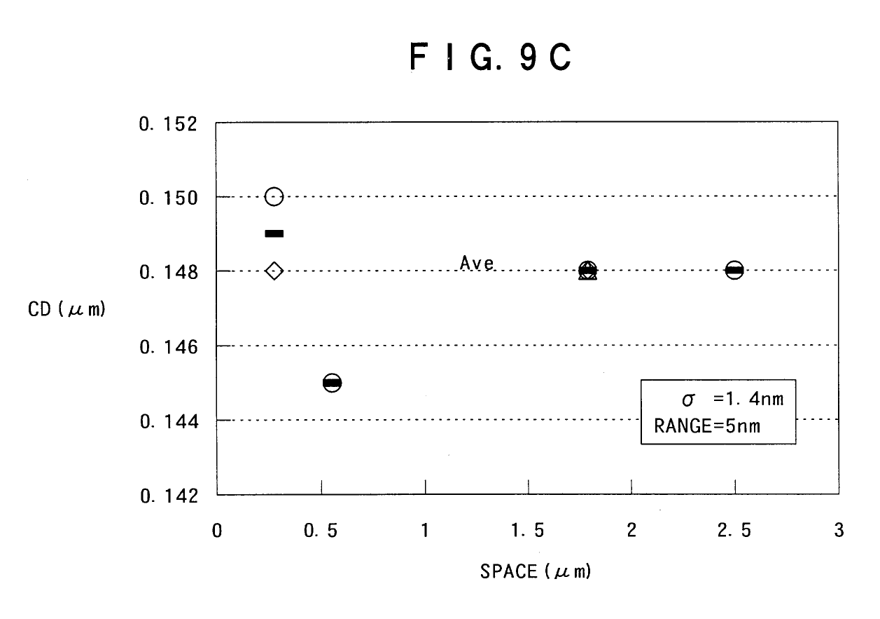

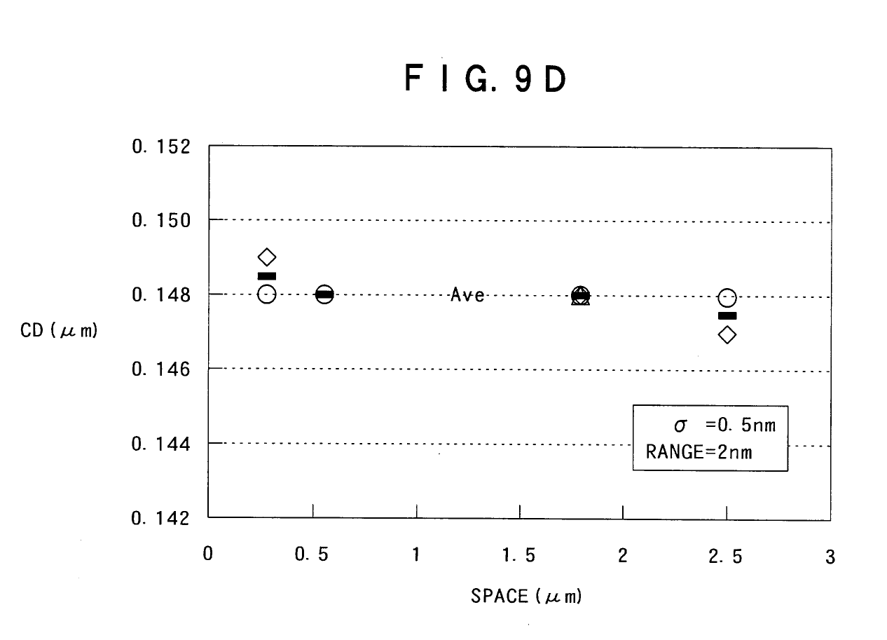

FIGS. 9A to 9D are diagrams illustrating the comparison of dispersions of each kind of simulation data of gate patterns on a mask of an actual product. The design data (target value) of the line width of the gate patterns is 150 nm.

In the figures, the axis of abscissas represents the space (interval) between the gate patterns in the line width direction in terms of μm, and the axis of ordinates represents the line width DC of the gate patterns in terms of μm.

In the figures, ◯, Δ, and ⋄ respectively indicate simulation data at different portions (locations) of gate pattern.

FIG. 9A shows the simulation data based on only the existing test pattern, FIG. 9B shows the simulation data in the case where simulation for the first pattern groups is conducted in addition to the simulation for the existing test pattern, FIG. 9C shows the simulation data in the case where simulation for the second pattern groups is conducted in addition to the simulations for the existing test pattern and the first test pattern, and FIG. 9D shows the simulation data in the case where simulation for the third pattern groups is conducted in addition to the simulations for the existing test pattern, the first test pattern and the second test pattern.

In the figures, a represents the standard deviation of the simulation data, and RANGE represents the difference between the maximum and the minimum of the simulation data.

It is seen from FIGS. 9A to 9B that the simulation data shown in FIGS. 9B and 9D have smaller values of a and RANGE, namely, a smaller dispersion, as compared with the simulation data based on only the existing test pattern shown in FIG. 9A.

In comparison between FIG. 9B and FIG. 9D, RANGE of FIG. 9B is 1 nm while that of FIG. 9D is 2 nm, so that FIG. 9B is smaller in dispersion. However, as for the simulation data for a space of 1.8 μm, a plurality of simulation data coincide with each other in FIG. 9D. Therefore, the accuracy of simulation data can be evaluated to be higher in FIG. 9D than in FIG. 9B.

As has been described above, according to the method of producing an OPC mask, the OPC mask and a chip according to the present embodiment, the kernel used for the above-mentioned simulation is generated based on a test pattern containing at least one of the first, second and third pattern groups, so that it is possible to perform a simulation with the influences of space dependency of gate patterns faithfully reflected thereon. Therefore, by correcting the design data of the shape of the mask pattern so that the shape of the pattern transferred onto the wafer will coincide with the desired shape based on the design data, based on the results of simulation computation, it is possible to restrain dispersion of the line width of the patterns actually formed on the wafer and the chips.

While the number of groups in each kind of the first to third pattern groups has been described to be four in the present embodiment, the number may be arbitrary as far as it is plural.

As has been described above, according to the present invention, a simulation with the influences of space dependency of gate patterns faithfully reflected thereon can be performed by use of a kernel generated by performing simulations based on the first, second and third pattern groups, whereby the dispersion of the line width of the patterns actually formed on the wafer and chips can be suppressed.

1. A method of producing an OPC mask, comprising:
a simulation step for determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account, and
a correction step for correcting design data of the shape of said mask pattern so that the shape of said pattern transferred onto said wafer will coincide with the desired shape based on said design data, based on the results of said simulation step,
said simulation step being performed by use of a simulation model expressing the process of transfer of said mask pattern, namely, a kernel, wherein
said kernel is generated based on design data of the shape of a test mask pattern and measured data of the shape of a test wafer pattern actually formed by transfer and etching conducted by use of said test mask pattern,
said test pattern contains a plurality of first pattern groups each constituted by arranging a plurality of belt form gate patterns in parallel to each other and at the same interval in the line width direction, each of said gate patterns having a line width substantially equal to said predetermined minimum size and extending in a linear form, and
said plurality of first pattern groups differ from each other in the size of said interval of said gate patterns.

2. A method of producing an OPC mask according to claim 1, wherein said test pattern contains a plurality of second pattern groups each constituted by arranging a plurality of belt form gate patterns in parallel to each other and at the same interval in the line width direction, each of said gate patterns having a line width smaller than said predetermined minimum size and extending in a linear form, and said plurality of second pattern groups differ from each other in the size of said interval of said gate patterns.

3. A method of producing an OPC mask according to claim 1 or 2, wherein said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and said plurality of third pattern groups differ from each other in the size of said interval of said gate patterns.

4. A method of producing an OPC mask, comprising:
a simulation step for determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account, and
a correction step for correcting design data of the shape of said mask pattern so that the shape of said pattern transferred onto said wafer will coincide with the desired shape based on said design data, based on the results of said simulation step,
said simulation step being performed by use of a simulation model expressing the process of transfer of said mask pattern, namely, a kernel, wherein
said kernel is generated based on design data of the shape of a test mask pattern and measured data of the shape of a test wafer pattern actually formed by transfer and etching conducted by use of said test mask pattern,
said test pattern contains a plurality of second pattern groups each constituted by arranging a plurality of belt form gate patterns in parallel to each other and at the same interval in the line width direction, each of said gate patterns having a line width smaller than said predetermined minimum size and extending in a linear form, and
said plurality of second pattern groups differ from each other in the size of said interval of said gate patterns.

5. A method of producing an OPC mask according to claim 4, wherein said test pattern contains a plurality of third pattern groups each constituted by arranging a plurality of gate patterns in parallel to each other and at the same interval in the line width direction, each of said gate patterns having a line width greater than said predetermined minimum size and extending in a linear form, and said plurality of third pattern groups differ from each other in the size of said interval of said gate patterns.

6. A method of producing an OPC mask, comprising:
a simulation step for determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account, and
a correction step for correcting design data of the shape of said mask pattern so that the shape of said pattern transferred onto said wafer will coincide with the desired shape based on said design data, based on the results of said simulation step,
said simulation step being performed by use of a simulation model expressing the process of transfer of said mask pattern, namely, a kernel, wherein
said kernel is generated based on design data of the shape of a test mask pattern and measured data of the shape of a test wafer pattern actually formed by transfer and etching conducted by use of said test mask pattern,
said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and
said plurality of third pattern groups differ from each other in the size of said interval of said gate patterns.

7. An OPC mask produced by the steps of:
determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account,
correcting design data of the shape of said mask pattern so that the shape of said pattern transferred onto said wafer will coincide with the desired shape based on said design data, based on the results of said simulation computation,
said simulation computation being performed by use of a simulation model expressing the process of transfer of said mask pattern, namely, a kernel, and
producing said OPC mask based on said corrected design data, wherein
said kernel is generated based on design data of the shape of a test mask pattern and measured data of the shape of a test wafer pattern actually formed by transfer and etching conducted by use of said test mask pattern,
said test pattern contains a plurality of first pattern groups each constituted by arranging a plurality of belt form gate patterns in parallel to each other and at the same interval in the line width direction, each of said gate patterns having a line width substantially equal to said predetermined minimum size and extending in a linear form, and
said plurality of first pattern groups differ from each other in the size of said interval of said gate patterns.

8. An OPC mask according to claim 7, wherein said test pattern contains a plurality of second pattern groups each constituted by arranging a plurality of belt form gate patterns in parallel to each other and at the same interval in the line width direction, each of said gate patterns having a line width smaller than said predetermined minimum size and extending in a linear form, and said plurality of second pattern groups differ from each other in the size of said interval of said gate patterns.

9. An OPC mask according to claim 7 or 8, wherein said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and said plurality of third pattern groups differ from each other in the size of said interval of said gate patterns.

10. An OPC mask produced by the steps of:
determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account,
correcting design data of the shape of said mask pattern so that the shape of said pattern transferred onto said wafer will coincide with the desired shape based on said design data, based on the results of said simulation computation,
said simulation computation being performed by use of a simulation model expressing the process of transfer of said mask pattern, namely, a kernel, and
producing said OPC mask based on said corrected design data, wherein
said kernel is generated based on design data of the shape of a test mask pattern and measured data of the shape of a test wafer pattern actually formed by transfer and etching conducted by use of said test mask pattern,
said test pattern contains a plurality of second pattern groups each constituted by arranging a plurality of belt form gate patterns in parallel to each other and at the same interval in the line width direction, each of said gate patterns having a line width smaller than said predetermined minimum size and extending in a linear form, and
said plurality of second pattern groups differ from each other in the size of said interval of said gate patterns.

11. An OPC mask according to claim 10, wherein said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and said plurality of third pattern groups differ from each other in the size of said interval of said gate patterns.

12. An OPC mask produced by the steps of:
determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account,
correcting design data of the shape of said mask pattern so that the shape of said pattern transferred onto said wafer will coincide with the desired shape based on said design data, based on the results of said simulation computation,
said simulation computation being performed by use of a simulation model expressing the process of transfer of said mask pattern, namely, a kernel, and
producing said OPC mask based on said corrected design data, wherein
said kernel is generated based on design data of the shape of a test mask pattern and measured data of the shape of a test wafer pattern actually formed by transfer and etching conducted by use of said test mask pattern,
said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and
said plurality of third pattern groups differ from each other in the size of said interval of said gate patterns.

13. A chip diced from a wafer produced based on an OPC mask, said OPC mask being produced by the steps of:
determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account,
correcting design data of the shape of said mask pattern so that the shape of said pattern transferred onto said wafer will coincide with the desired shape based on said design data, based on the results of said simulation computation,
said simulation computation being performed by use of a simulation model expressing the process of transfer of said mask pattern, namely, a kernel, and
producing said OPC mask based on said corrected design data, wherein
said kernel is generated based on design data of the shape of a test mask pattern and measured data of the shape of a test wafer pattern actually formed by transfer and etching conducted by use of said test mask pattern,
said test pattern contains a plurality of first pattern groups each constituted by arranging a plurality of belt form gate patterns in parallel to each other and at the same interval in the line width direction, each of said gate patterns having a line width substantially equal to said predetermined minimum size and extending in a linear form, and
said plurality of first pattern groups differ from each other in the size of said interval of said gate patterns.

14. A chip according to claim 13, wherein said test pattern contains a plurality of second pattern groups each constituted by arranging a plurality of belt form gate patterns in parallel to each other and at the same interval in the line width direction, each of said gate patterns having a line width smaller than said predetermined minimum size and extending in a linear form, and said plurality of second pattern groups differ from each other in the size of said interval of said gate patterns.

15. A method of producing an OPC mask according to claim 13 or 14, wherein said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and said plurality of third pattern groups differ from each other in the size of said interval of said gate patterns.

16. A chip diced from a wafer produced based on an OPC mask, said OPC mask being produced by the steps of:
determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account,
correcting design data of the shape of said mask pattern so that the shape of said pattern transferred onto said wafer will coincide with the desired shape based on said design data, based on the results of said simulation computation,
said simulation computation being performed by use of a simulation model expressing the process of transfer of said mask pattern, namely, a kernel, and
producing said OPC mask based on said corrected design data, wherein
said kernel is generated based on design data of the shape of a test mask pattern and measured data of the shape of a test wafer pattern actually formed by transfer and etching conducted by use of said test mask pattern,
said test pattern contains a plurality of second pattern groups each constituted by arranging a plurality of belt form gate patterns in parallel to each other and at the same interval in the line width direction, each of said gate patterns having a line width smaller than said predetermined minimum size and extending in a linear form, and
said plurality of second pattern groups differ from each other in the size of said interval of said gate patterns.

17. A chip according to claim 16, wherein said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and said plurality of third pattern groups differ from each other in the size of said interval of said gate patterns.

18. A chip diced from a wafer produced based on an OPC mask, said OPC mask being produced by the steps of:
determining the difference between the shape of a mask pattern designed according to a design rule defined by a predetermined minimum size value and formed on a mask and the shape of a pattern transferred onto a wafer by use of said mask pattern, by simulation computation taking the optical proximity effect into account,
correcting design data of the shape of said mask pattern so that the shape of said pattern transferred onto said wafer will coincide with the desired shape based on said design data, based on the results of said simulation computation,
said simulation computation being performed by use of a simulation model expressing the process of transfer of said mask pattern, namely, a kernel, and
producing said OPC mask based on said corrected design data, wherein
said kernel is generated based on design data of the shape of a test mask pattern and measured data of the shape of a test wafer pattern actually formed by transfer and etching conducted by use of said test mask pattern,
said test pattern contains a plurality of third pattern groups each constituted by arranging a plurality of belt form gate patterns in parallel to each other and at the same interval in the line width direction, each of said gate patterns having a line width greater than said predetermined minimum size and extending in a linear form, and
said plurality of third pattern groups differ from each other in the size of said interval of said gate patterns.
